(19) United States
(12) Patent Application Publication
(10) Pub. No.: US 2008/0168047 A1
(43) Pub. Date: Jul. 10, 2008

(54) System and method for anonymous mail delivery services

(75) Inventor: Koushik Chatterjee, Orlando, FL (US)

Correspondence Address: PATTON BOGGS, LLP, 2001 ROSS AVENUE, SUITE 3000, DALLAS, TX, 75201, US

(73) Assignee: Embarq Holdings Company, LLC

(21) Appl. No.: 11/649,606

(22) Filed: Jan. 4, 2007

(51) Int. Cl. G06F 7/10; G06F 17/30

(52) U.S. Cl. 707/5; 707/3; 707/E17.014

(57) ABSTRACT

A process for providing anonymous mail services including receiving mail to be delivered to a recipient, where the mail includes an identifier of the recipient and does not include an address or indicia of an address, looking up an address of the recipient using the identifier of the recipient, and delivering the mail to the address of the recipient. The identifier of the recipient may be an alphanumeric code. Looking up an address of the recipient may include querying a database to locate the address of the recipient. Querying the database may include querying a database over a network such as the Internet.

### BACKGROUND

Mail delivery services use physical addresses to deliver mail to individuals and businesses. There are many reasons why people want to remain anonymous when receiving mail For example, for security and privacy reasons, famous and wealthy people avoid letting others know where they live and what they are purchasing. Such security and privacy concerns are heightened in the case of purchasing goods from a catalog or the Internet. With the increased use of the Internet, security concerns of all people who purchase products from websites, such as eBay®, also have a desire to avoid having many people know their home addresses. Further, online communities, such as chat sites and dating websites, enable people to meet anonymously and communicate via chat and email in an anonymous manner as no physical location can be identified between two online parties. However, if the two parties want to share a physical object, such as a letter, gift, or otherwise, one of the parties must provide a physical address to the other.

To maintain anonymity, people have traditionally used post office boxes and other remote locations, such as mailboxes at retail businesses (e.g., Mailboxes Etc.®). While these anonymity techniques protect people's residential and/or work locations, they can be expensive, inconvenient, and problematic as some parties cannot or will not ship to a mailbox and some mail carrier services will not deliver to a mailbox. For the purposes of this application, “mail” is considered to be any letter, envelope, card, box, parcel, package, item, or other physical object that can be mailed or shipped via a mail delivery service (e.g., U.S. Postal Service (USPS), Federal Express (FedEx), and United Parcel Service (UPS)).

FIG. 1 is an illustration of a conventional community 100 including residential properties 102a-102n (collectively 102) and commercial properties 104. A mail delivery system 106 is representative of mail delivery services 108a-108n (collectively 108) that are used to transport mail 110 between parties (i.e., a sender to a recipient). As understood in the art, a mail delivery service may be any thin party mail delivery service that uses any mode of transportation to transport the mail.

Mail that is sent using conventional mail delivery services must include an address of a recipient and, optionally, an address of the sender (“return address”). FIG. 1B is an exemplary mail item 110 having an address 112 printed thereon to enable a mail delivery service to route and deliver the mail item 110. While it is possible for a sender to maintain an anonymous address, it is not possible for a recipient to maintain an anonymous address by not including a return address 114 on the mail item 110. Not being able to receive mail anonymously means that a receiving party is non-anonymous to a sending party, spends money on a private mailbox, or has the mail delivered to a remote location other than his or her residence or work location, which may be inconvenient. Recipients who receive mail at their home or office face privacy and security concerns due to their giving others, possibly online predators, their home or office address.

### SUMMARY

To overcome the problem of privacy and security concerns when using conventional mail delivery services, the principles of the present invention provide for a receiving party to provide a sending party with an identifier that can be used by a traditional mail delivery service to look up an address to deliver the mail Because a receiving party may provide a sending party with an identifier rather than a physical address, the receiving party's anonymity is preserved, thereby maintaining the receiving party's privacy and safety.

One embodiment for enabling anonymous mail service includes a system including a database configured to store data records including an identifier and address. A computing system may be in communication with the database and be configured to generate a user interface enabling a user to enter an identifier associated with a recipient of a mail item, receive the identifier associated with the mail item to retrieve an address to where the mail item is to be delivered, query the database with the identifier to locate a data record including the identifier, receive an address contained in the data record including the identifier, and communicate the address to the user via the user interface.

A process for providing anonymous mail services in accordance with the principles of the present invention may include receiving mail to be delivered to a recipient, where the mail includes an identifier of the recipient and does not include an address or indicia of an address, looking up an address of the recipient using the identifier of the recipient, and delivering the mail to the address of the recipient. The identifier of the recipient may be an alphanumeric code. Looking up an address of the recipient may include querying a database to locate the address of the recipient. Querying the database may include querying a database over a network such as the Internet.

### BRIEF DESCRIPTION OF THE DRAWINGS

Illustrative embodiments of the present invention are described in detail below with reference to the attached drawing figures, which are incorporated by reference herein and wherein:

FIG. 1A is an illustration of a conventional community including residential properties and commercial properties between which mail is delivered;

FIG. 1B is an exemplary mail item including a name and address for each of the sender and recipient;

FIG. 2A is the conventional community including residential properties and commercial properties between which mail maybe delivered to recipients in an anonymous manner,

FIG. 2B is an illustration of the exemplary mail item of FIG. 2A on which an identifier is included to identify a recipient of the mail item;

FIG. 2C is the mail item of FIG. 2B having a mailing label placed thereon that includes a name and address of the recipient;

FIG. 3 is an illustration of an exemplary system for providing anonymous mail services in accordance with the principles of the present invention;

FIG. 4 is a screenshot of an exemplary graphical user interface that enables a receiving party to register for anonymous mail delivery services;

FIG. 5 is an illustration of an exemplary confirmation email in response to a registrant registering for anonymous mail delivery services;

FIG. 6 is an illustration of an exemplary letter sent to a registrant in response to registering for anonymous mail delivery services;

FIG. 7 is an illustration of an exemplary webpage used to notify a registrant of anonymous mail services of an identifier for providing other parties to send the registrant mail anonymously;

FIG. 8 is a webpage of an exemplary registry index for looking up recipients who have registered for anonymous mail delivery services;

FIG. 9 is an illustration of an exemplary mail label including a barcode of an identifier for mailing a mail item to a recipient without knowing the recipient's mail address;

FIG. 10 is a graphical user interface of an exemplary login screen for registrants of anonymous mail delivery services;

FIG. 11 is a graphical user interface of an exemplary webpage containing a history list of mail delivered to registrants of anonymous mail delivery services;

FIG. 12 is a graphical user interface of an exemplary webpage containing a sent mail list from registrants of an anonymous mail delivery service; and

FIG. 13 is a webpage of an exemplary index screen for looking up contact information of registrants for anonymous telephone calls.

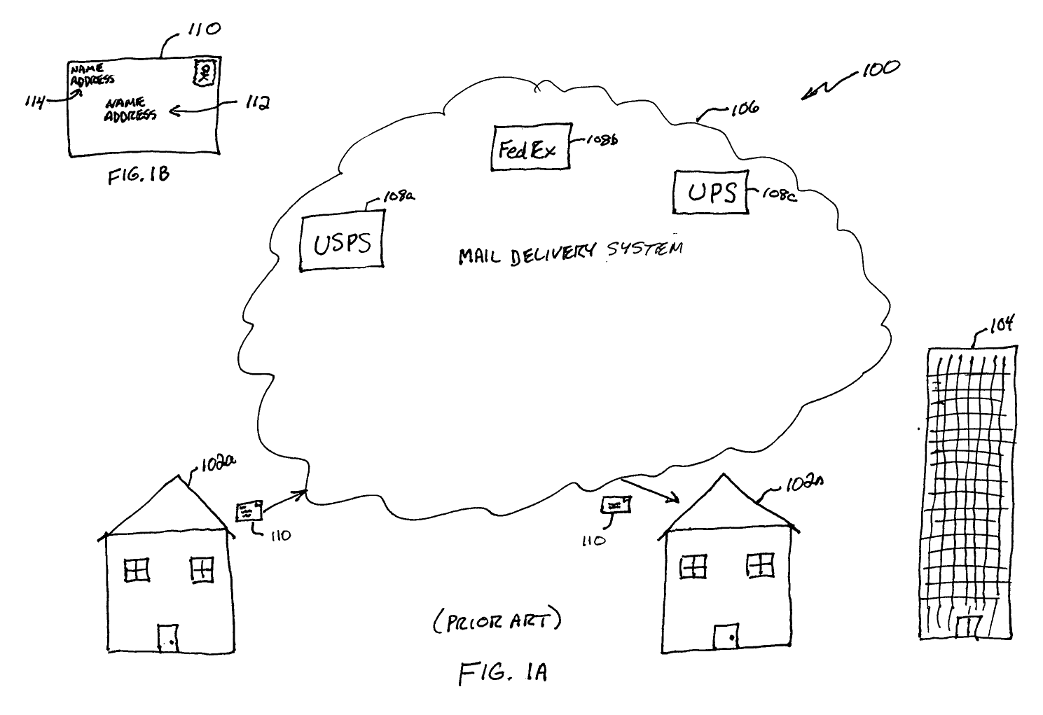

### DETAILED DESCRIPTION OF THE DRAWINGS

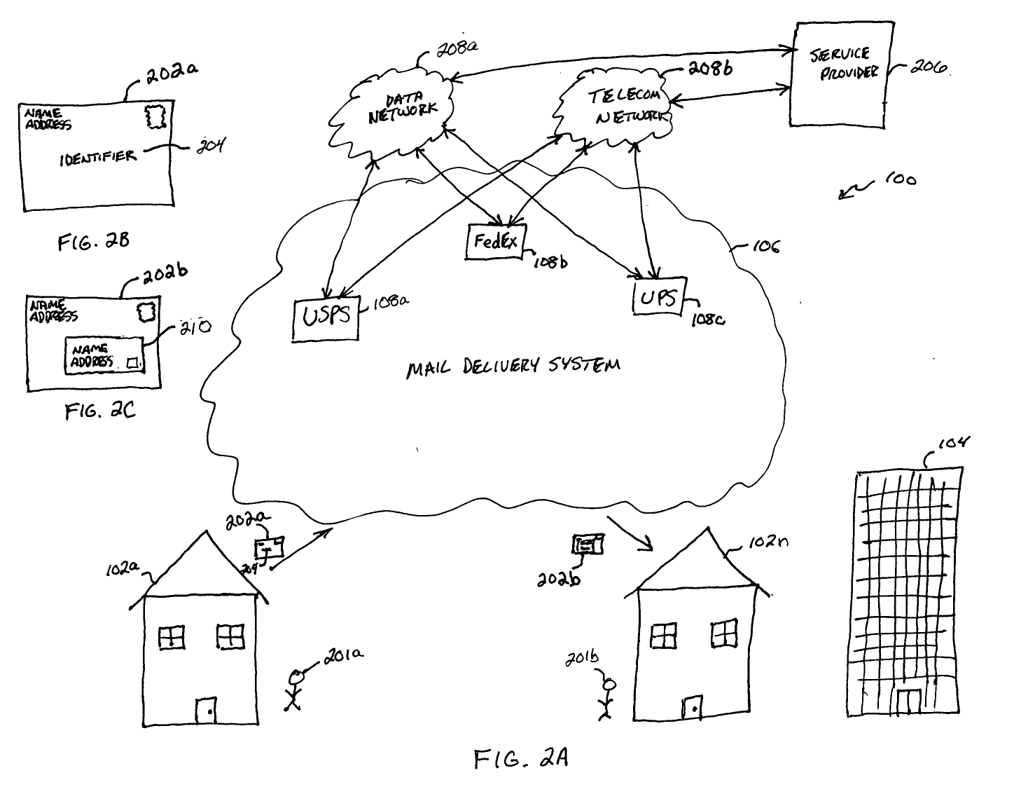

FIG. 2A is the conventional community 100 including residential properties 102 and commercial properties 104 between which mail may delivered in an anonymous manner. As shown, a mail item 202a may be sent from a sending party or sender 201 living at residence 102a to a receiving party or receiver 201b living at residence at 102n. In this scenario, the receiving party 201b has told the sending party 201a his or her identifier 204 that the sending party 201a prints on the mail item 202a. FIG. 2B is an illustration of the exemplary mail item 202a of FIG. 2a on which an identifier 204 is included to identify a recipient and/or delivery address of the mail item. The identifier 204 may be an alphanumeric code or other indicia (e.g., barcode) and be printed where a conventional mailing address would be printed. Alternatively, the identifier 204 may be printed elsewhere on the mail item 202a, such as a lower corner, notify a mail carrier service of the significance of the identifier. This identifier 204 may be used by a mail carrier service (e.g. USPS 108a) to determine the actual mailing address of the receiving party 201b with whom which the identifier 204 is associated.

Continuing with FIG. 2A, a service provider 206, which may provide telecommunications services, network services, and/or database management or hosting services, may be in communication with a data network 208a and telecommunications network 208b. The mail delivery services 108 may also be in communication with the data network 208a and telecommunications network 208b. The data network 208a may be the Internet or other data network and the telecommunications network 208b may be the public switched telephone network (PSTN), wireless network, combination thereof, or any other telecommunications network.

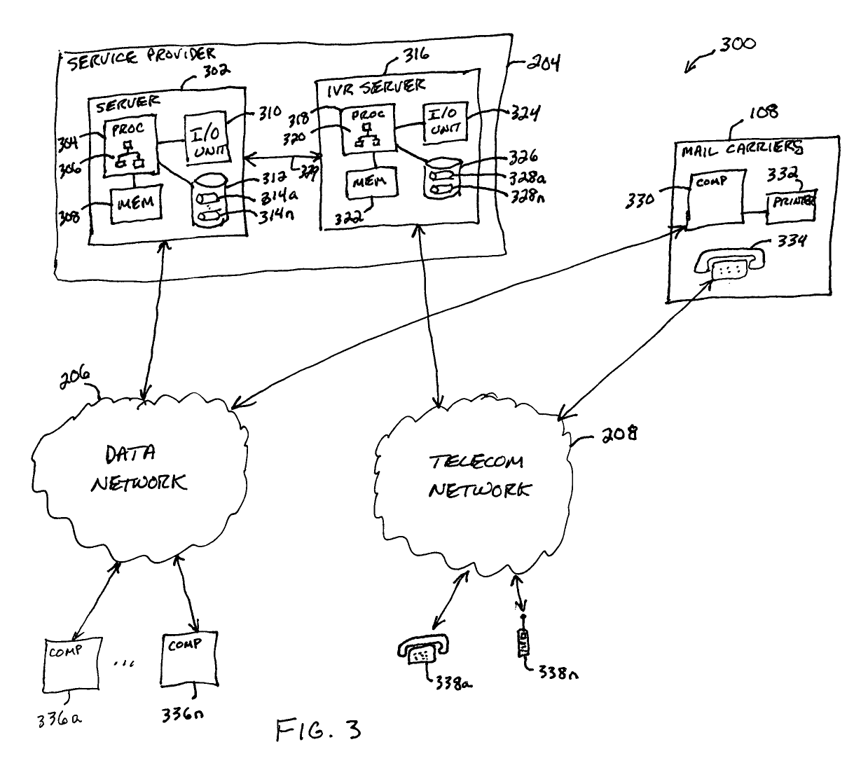

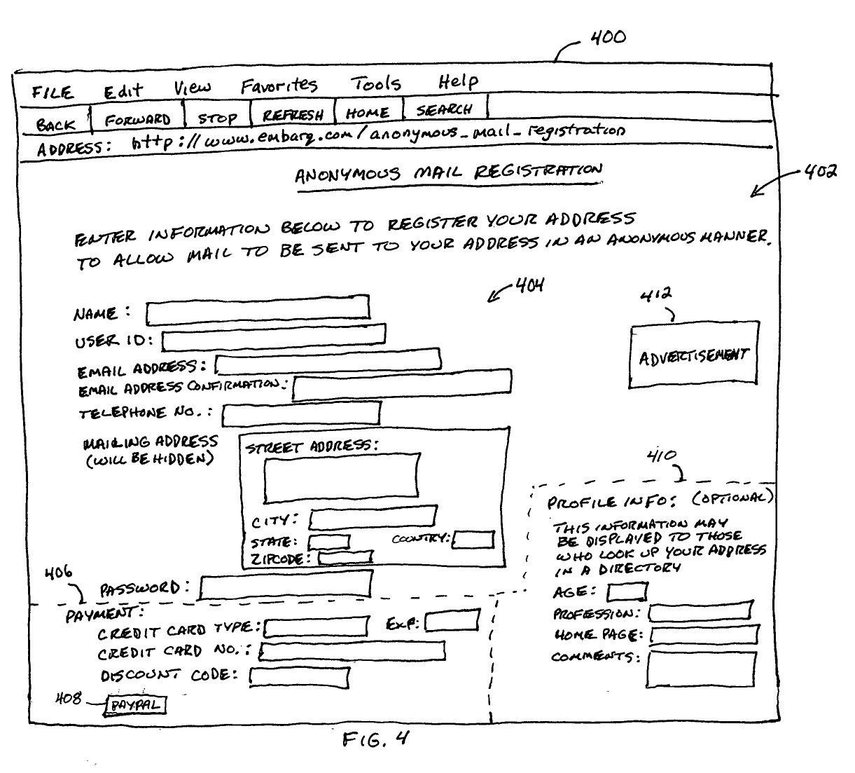

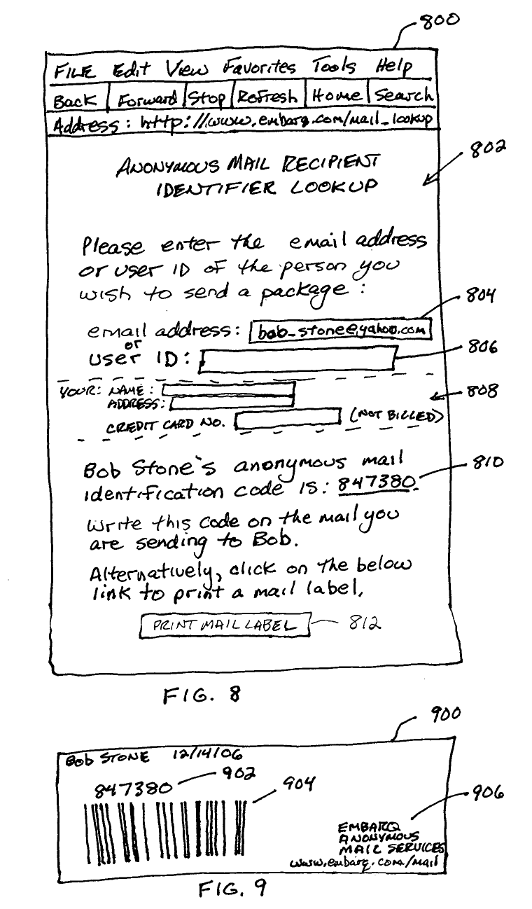

When a mail delivery service receives a mail item, the mail delivery service 108 may communicate with the service provider 206 to determine an address associated with the identifier. In communicating with the service provider 206, the mail delivery service 108 may use a computing system (see, FIG. 3) to interface with a user interface or place a telephone call to an operator, either automatic or human, to submit the identifier and receive an address associated with the identifier. FIG. 2C is the mail item of FIG. 2B having a sticker placed thereon that includes a name and address of the recipient. As shown, a recipient's address is placed on a mail label 210 over the identifier 204 (FIG. 2B) so that the mail delivery service may deliver the mail item 202b to the residence 102n of the recipient 201b of the mail item 202b. It should be understood that the mail label 210 may also include the name of the mail recipient depending upon how the mail recipient sets up his or her level of security with the service provider 206, which is further described in association with FIG. 3. In addition, the mail label 210 may be placed elsewhere on the mail item 202b to avoid covering the identifier 204 in case the identifier 204 is needed at a later date. In the case of the identifier 204 being placed in a bottom corner, the mail label 210 may be more easily positioned to avoid covering the identifier 204. In one embodiment, the mail label 210 may include a website address of the anonymous mail service (see, FIG. 9) to enable a recipient to visit the website. The website address may include a soft-button to enable the mail recipient to select to request a de-activation code to be mailed to the address of the recipient so that the recipient may deactivate and delete the account listing in the event that the account was set up by a friend playing a practical joke on the recipient or an enemy using the anonymous mail service to cause trouble for the recipient.

FIG. 3 is an illustration of an exemplary system 300 for providing anonymous mail services in accordance with the principles of the present invention. As shown, the service provider 204 may operate a server 302 that includes a processor 304 executing software 306. The processor may be in communication with memory 308 that is used to store data and software code during execution of the software 306, input/output (I/O) unit 310 that communicates with remote devices from the server 302, and storage unit 312 that is used to store one or more data repositories 314a-314n (collectively 314). The date repositories 314 may be one or more databases that are used to store information associated with parties who have registered to receive mail from senders in an anonymous manner through the use of identifiers.

The software 306 may be utilized to generate one or more webpages and communicate with the data repositories 314 for storage of the information associated with the recipients and enable recipient parties to manage their account as described further herein. Further the software 306 may be configured to enable individuals and businesses who desire receiving mail anonymously (i.e., without giving their physical addresses to senders) to register for anonymous mail delivery services and mail carriers 108 to access the data repositories 314 to look up physical addresses based on identifiers associated with the registered individuals and businesses. A security level system may be managed by the software. For example, employees of a mail carrier may access state and zip code associated with identifiers with a level 3 security clearance, street addresses with a level 2 security clearance, and names and street addresses with a level 1 security clearance.

In addition, the service provider may operate an interactive voice response (IVR) server 316 that includes a processor 318 that executes software 320. The processor 318 may be in communication with a memory 322, I/O unit 324, and storage unit 326. The storage unit 326 may store data repositories 328a-328n (collectively 328) that are utilized to store information associated with registrants of the anonymous mail delivery services. In one embodiment, the information stored in the data repositories 328 is the same or similar as that stored in the data repositories 314. As understood in the art, the software 320 executed by the processor 318 allows for interactive voice responses and/or dual-tone multiple frequency (DTMF) responses from a caller to the interactive voice response server 316. In the case of a registrant attempting to register him or herself for anonymous mail delivery services, the interactive voice response server 316 may prompt the registrant with questions, such as “please speak your home address.” The software 320 may further be utilized to activate the anonymous mail delivery services by prompting a registrant for information associated with registration for the anonymous mail delivery services. Still yet, the software 320 may be utilized to respond to calls from mail delivery services 108 for determining addresses associated with identifiers of registered mail recipients for the anonymous mail delivery services.

In one embodiment, the interactive voice response server 316 may communicate with the server 302 via communication link 329. The communication link 329 may enable the processors 318 and 304 to communicate with one another to share information stored in one or both of the respective data repositories 328 and 314 or to communicate response information from registrants responding to prompts from the interactive voice response server 316, for example. In communicating across the link 329, the respective I/O units 324 and 310 may be utilized. It should be understood that while both the server 302 and interactive voice response server 316 are shown to be operated by the service provider, that a third party may operate one or both of the servers 302 and 316.

The mail delivery services 108 may utilize computers 330, printers 332, and telephones 334 to communicate identifier information associated with mail recipients to determine address information of the mail recipient. The mail carriers 108 may use the printers 332 to print mailing labels with the addresses and/or names of the recipients in place on the mail items.

As further shown, individuals and/or businesses may utilize computers 336a-336n (collectively 336) and telephones 338a-338n (collectively 338) to communicate with the server 302 and/or IVR server 316 of the service provider 204 in registering, activating and managing accounts for registrants of the anonymous mail delivery services as further described herein.

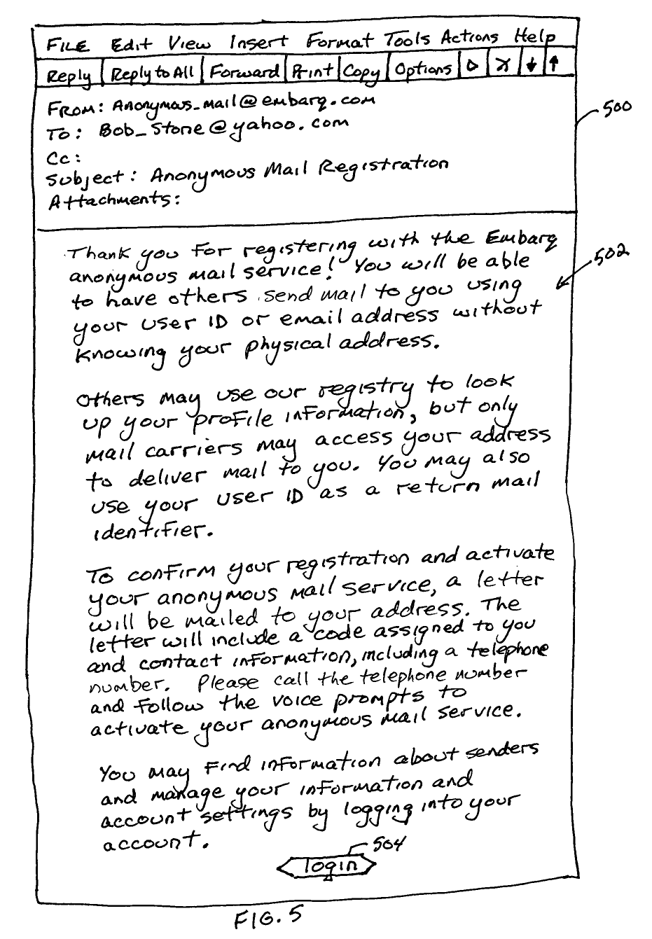

FIG. 4 is a screenshot of an exemplary graphical user interface that enables a receiving party to register for anonymous mail delivery services. The webpage 402 may request a registrant for the anonymous mail delivery services to enter his or her name, a user ID, email address, and telephone number. The user ID and/or email address may be utilized by the registrant to access his or her account for managing various aspects of the anonymous mail delivery services. In addition, the registrant is requested to enter an address, including a street address, city, state, zip code, and country. The mailing address remains hidden from anyone else other than mail delivery services that use the address to deliver mail to the registrant. In other words, another user who looks up information associated with the name, user ID, or email address of the registrant is not able to access the physical address of the registrant as this information is deemed private to the registrant. A password may also be requested from the registrant to access an account via a website.

In addition to the contact information requested from the registrant, payment information may also be requested from the registrant. The payment information may be located in a pane 406 of the webpage 402 and request credit card type, credit card number, expiration date, and discount code, if any. Alternatively, the registrant may select a soft-button 408 for using a Paypal® account to pay for the anonymous mail delivery services. The payment may be a monthly service charge that is independent of the number of anonymous mail deliveries to the registrant, fixed amount based on the number of anonymous mail deliveries made to the registrant, weight-based payment based on the size and weight of the mail delivered to the recipient of the anonymous mail delivery services, or any other payment plan for a recipient to utilize and receive mail via the anonymous mail delivery services in accordance with the principles of the present invention.

In addition to contact information and payment information, another pane 410 of the website 402 may be utilized to request profile information that may be optionally entered by the registrant and used for posting in a registry associated with the registrant. For example, age, profession, home page, and comments may be requested from the registrant and accessed by others in looking up a registrant using his or her name, user ID, or email address so that they can confirm that this registrant is who the other person (e.g., sender of mail) believes them to be. In addition, an advertisement may be posted on the anonymous registration website 402.

FIG. 5 is an illustration of an exemplary confirmation email 500 in response to a registrant registering for anonymous mail delivery services. In response to completing a registration, the service provider may send an email to the registrant that notifies the registrant of how the anonymous mail service works and allows the registrant to confirm the registration and activate the anonymous mail service. Alternatively, as shown in the email text 502, this confirmation email alerts the registrant that a letter will be mailed to his or her address and that the letter will include a code and contact information that the registrant will need to contact and supply the code prior to receiving an identifier for the registrant to use in receiving anonymous mail delivery services. Alternatively, the identifier may simply be provided to the registrant at the time or via a later communication. Additionally, a soft-button 504 may be provided that enables the registrant to log into his or her account to manager information and settings for the anonymous mail services.

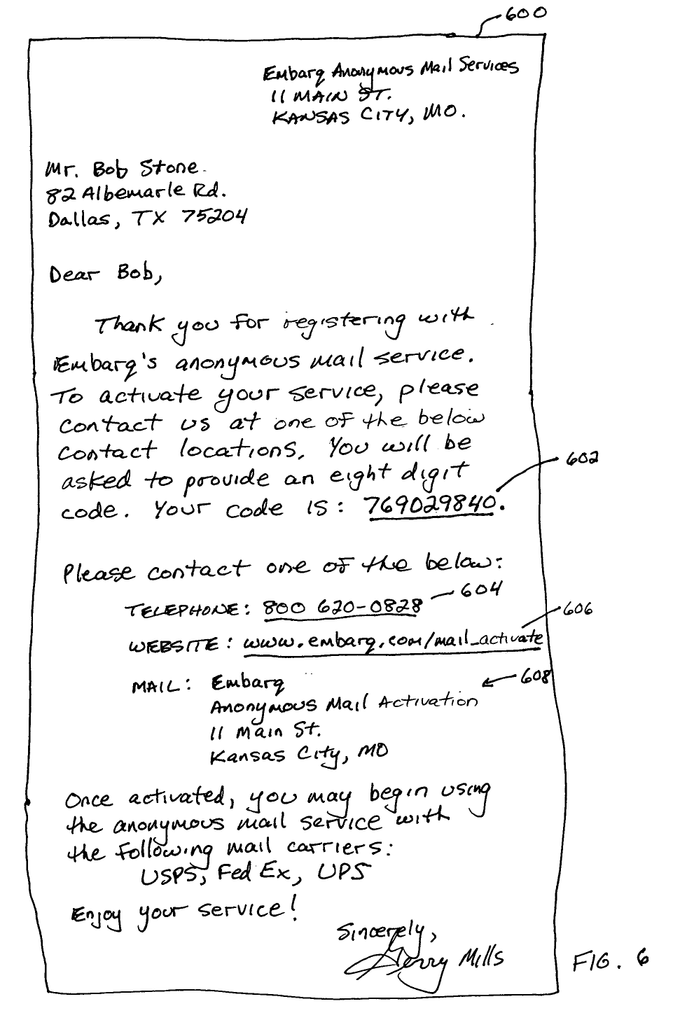

FIG. 6 is an illustration of an exemplary letter 600 sent to a registrant in response to registering for anonymous mail delivery services. The letter 600 may provide a code 602 (e.g., 769029840). The code 602 is to be used in activating the anonymous mail service by contacting a service provider or third party at a contact location, either telephone number 604, website address 606, or physical address 608. By sending a letter to the address of the registrant, when the registrant activates his or her anonymous mail service, the service provider ensures that the physical address is, in fact, that of the registrant.

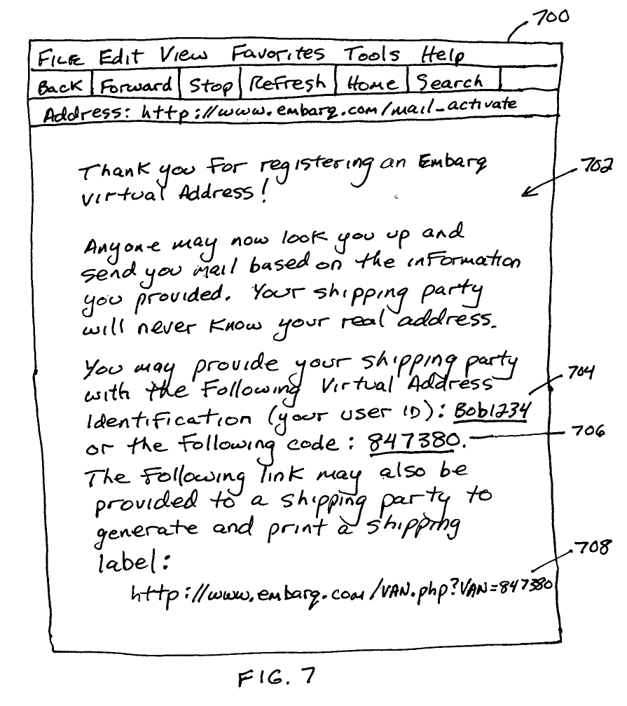

FIG. 7 is an illustration of an exemplary webpage 700 used to notify a registrant of anonymous mail services of an identifier for providing other parties to send the registrant mail anonymously. In response to the registrant activating his or her anonymous mail service, in this case via the Internet, a message 702 may be communicated to the registrant that includes a user ID 704 (e.g., Bob1234) and code 706 (e.g., 847380). Either of these identifiers 704 or 706 may be utilized for the anonymous mail delivery services as each are uniquely associated with the registrant. It should be understood that any other alphanumeric code may be utilized in accordance with the principles of the present invention. For example, a prefix or suffix may be added to the code to notify a mail carrier service of who the service provider is for a particular registrant of the anonymous mail services (e.g., “EMBQ” for Embark. Additionally, a web link 708 may be provided to a shipping party to generate and print a shipping label, where the shipping label may include the recipient's name and identifier in an alphanumeric print and/or barcode print format.

FIG. 8 is a webpage of an exemplary registry index 800 for looking up recipients who have registered for anonymous mail delivery services. Once a registrant of the anonymous mail service is activated, information associated with the registrant may be looked up at the registry index 800. As shown, a webpage 802 may request an email address or user ID from someone looking up an anonymous mail identifier of the anonymous mail service. In this case, a user may enter an email address, “bob_stone@yahoo.com”, in a text input field 804. Alternatively, the user may enter the user ID (e.g., “Bob1234”) in a text entry field 806 for looking up the anonymous mail identification code of the registrant of the anonymous mail service. It should be understood that other information, such as the registrant's name maybe requested from a user.

In addition to providing the recipients information, the user may be requested to enter his or her name, address, and credit card number prior to receiving the anonymous mail identification code of the registrant. Wile the user sending mail to the registrant of the anonymous mail service may not pay for delivery of anonymous mail to a registrant, the credit card number may be used for identification purposes and for tracking purposes. It should be understood, however, that the sender of mail via an anonymous mail delivery may be charged for a fee in some embodiments in accordance with the principles of the present invention. An anonymous mail identification code 810 may be provided to the user in response to the user entering an email address associated with the registrant. Again, because the anonymous mail identifier or identification code 810 is unique to the registrant, it may be utilized by a mail delivery service to look up the address of the registrant. In addition, the user may select a soft-button 812 to print a mail label that includes the identification code 810 of the registrant.

FIG. 9 is an illustration of an exemplary mail label 900 including a barcode of an identifier for mailing a mail item to a recipient without knowing the recipient's mail address (i.e., anonymous recipient). As shown, the mail label 900 may include a mail recipient's name, the date, identification code 902, bar code 904, which maybe representative of the identification code 902, and logo and/or name of the service provider (e.g., “Embarq Anonymous Mail Services”). Because the mailing label does not have the address or an indicia of the address of the registrant, a sender may not determine the physical address of the recipient, thereby maintaining privacy and security for the registrant of the anonymous mail service.

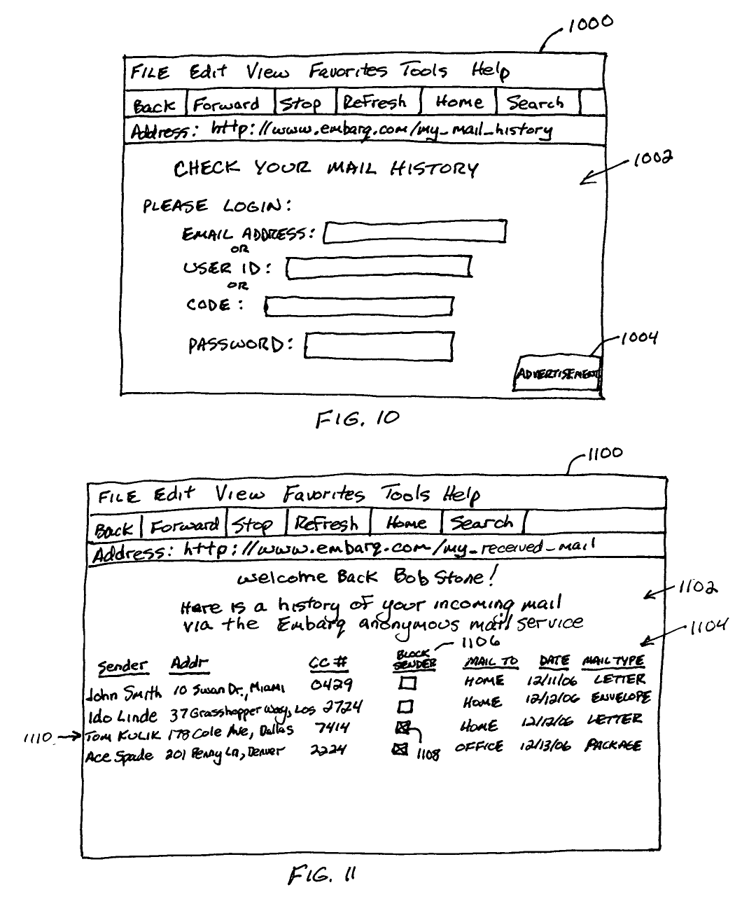

FIG. 10 is a graphical user interface 1000 of an exemplary login screen 1002 for registrants of anonymous mail delivery services. As shown in the login screen 1002, a registrant may log into his or her account by entering an email address, user ID, or identifier code and password. An advertisement 1004 may also be displayed on the user login webpage 1002.

FIG. 11 is a graphical user interface 1100 of an exemplary webpage 1102 containing a history list 1104 of mail delivered to registrants of anonymous mail delivery services. As shown, the registrant may access the webpage 1102 that has the history list 1104 of senders with their addresses and last four digits of their credit card, selectable elements 1106 for blocking particular senders, location as to where mail sent from the respective senders were sent (e.g., home or office), date of the mail sent from the respective senders, and mail type of the mail sent from the respective senders. In blocking senders from sending additional mail, a registrant may selectively mark or select a soft-button 1108 associated with a sender 1110. Thereafter, if a mail delivery service attempts to look up an address of a mail recipient who has blocked a particular sender, the system (e.g., server 302 of the service provider 204 (FIG. 3)) may deny the mail delivery service from accessing the address information associated with the identifier of the recipient. In determining that the sender is blocked from mailing the recipient, the system may use the sender's name, address and/or credit card number in making the determination. The history list 1104, in effect, may operate as a list of approved mailers.

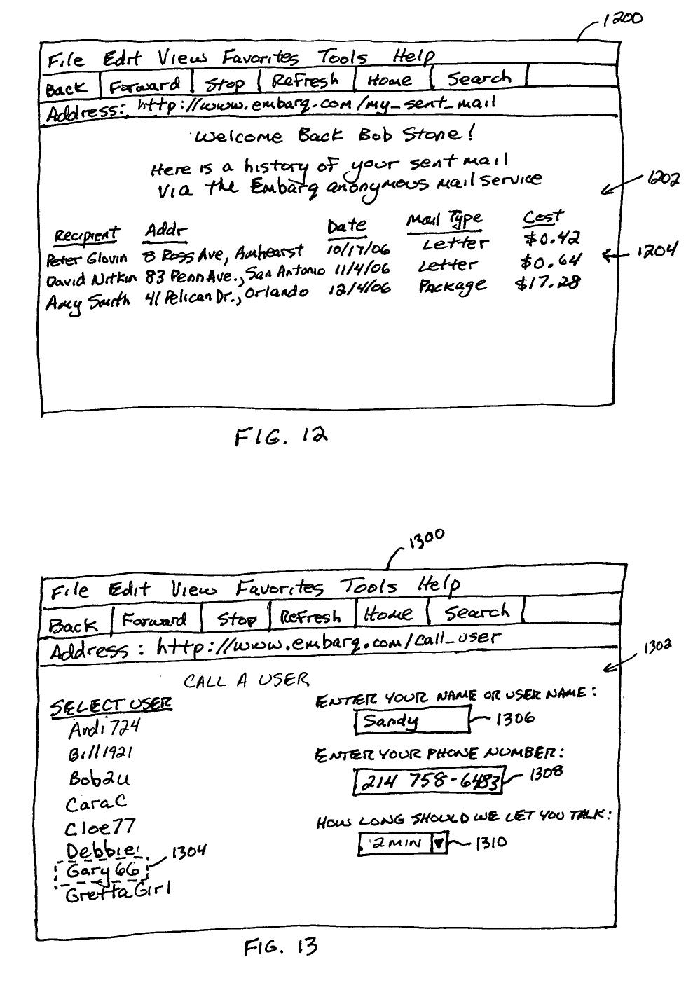

FIG. 12 is a graphical user interface 1200 webpage of an exemplary webpage 1202 containing a sent mail list from registrants of an anonymous mail delivery service. In addition to the mail recipient being able to manage his or her mail deliveries, the recipient or registrant may also be able to see a history of mail sent by him or her. The sent mail list 1202 may include a recipient, address, date, mail type, and cost of the mail sent by the registrant of the anonymous mail service. One way for this information to be collected is by the registrant using his or her identifier in a return address on the ma This may enable a mail carrier to enter or provide a service provider with information, such as a scan of the mail The information may be manually or automatically input depending upon the technology utilized for processing the mail. For example, if the mail is handwritten, the mail service may need to physically type in the information or use a handwriting analyzer on a computer to determine the mail information. Alternatively, barcodes may be used and read via a barcode scanner to collect the mail information. In one embodiment, the information in the list 1202 may be sorted by recipient, date, mail type, or cost.

FIG. 13 is a graphical user interface 1300 which may include a webpage 1302 of an exemplary index screen for looking up contact information of registrants for anonymous telephone calls. The webpage 1302 may be a front end of a registering that enabled a user to select a registered anonymous mail service registrant and call the anonymous mail service registrant at an anonymous telephone number (i.e., a telephone number not known to the caller). For example, a user may select a registrant 1304 and enter his or her name in a text input field 1306 and telephone number in a text input field 1308. In addition, the user may select or enter a time that he or she would like to talk to the registered user in a selection input field 1310 the system for providing anonymous telephone services may be that of the service provider 204 (FIG. 3) and as further described in co-pending U.S. patent application Ser. No. 11/526,549 filed on Sep. 25, 2006, which is herein incorporated in its entirety

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A system for enabling anonymous mail services, said system comprising:
a database configured to store data records including an identifier and address; and
a computing system in communication with said database, said computing system configured to:
generate a user interface enabling a user to enter an identifier associated with a recipient of a mail item;
receive the identifier associated with the mail item to retrieve an address to where the mail item is to be delivered;
query said database with the identifier to locate a data record including the identifier,
receive an address contained in the data record including the identifier, and
communicate the address to the user via the user interface.

2. The system according to claim 1, wherein said computing system is in communication with a network and the requester is remotely located from said computing system.

3. The system according to claim 1, wherein the network is the Internet.

4. The system according to claim 1, wherein the user interface is a webpage.

5. The system according to claim 1, wherein said computing system is further configured to generate a second user interface enabling the recipient to register the address and identifier within the database prior to receiving the address contained in the data record

6. The system according to claim 5, wherein said computing system, in response to the recipient requesting the user name and address, is configured to generate a code associated with the recipient and a data record containing the identifier.

7. The system according to claim 6, wherein said computing system is further configured to print a confirmation to be mailed to the address of the recipient, the confirmation including the code and contact information for the recipient to contact and confirm receipt of the confirmation.

8. The system according to claim 7, wherein said computing system is further configured to receive a communication from the recipient and verify a code submitted by the recipient matches the generated code stored in the data record with the identifier of the recipient.

9. The system according to claim 7, wherein the contact information is a telephone number.

10. The system according to claim 1, wherein the user interface is configured to print the address.

11. The system according to claim 10, wherein the print of the address is in a barcode format.

12. The system according to claim 1, wherein said database is further configured to store information indicative of mail deliveries to the recipient associated with the identifier stored in a record, and wherein said computing system is further configured to enable the recipient to view the mail delivery information stored in said database.

13. The system according to claim 12, wherein said database is further configured to store information to block a particular sender from sending mail to an address associated with recipient, and wherein said computing system is further configured to determine that mail is being sent from the particular sender to the mail recipient, and block the mail being sent to the recipient from the particular sender.

14. The system according to claim 12, wherein the information to block a particular sender is at least a portion of a credit card number.

15. The system according to claim 1, wherein said database is further configured to store information indicative of mail sent from a sender associated with an identifier stored in a record, and wherein said computing system is configured to enable the sender to view the mail sent and information stored in said database.

16. The system according to claim 1, wherein said database is further configured to store a telephone number in the data records, and wherein said computing system is further configured (i) to look up the telephone number in response to receiving an identifier, and (ii) cause a telephone call to be placed to the telephone number.

17. A method for enabling anonymous mail services, said method comprising:
generating a user interface enabling a user to enter an identifier associated with a recipient of a mail item;
receiving the identifier associated with the mail item from the user to retrieve an address to where the mail item is to be delivered;
locating a data record including the identifier,
retrieving an address contained in the data record including the identifier, and
communicating the address to the user.

18. The method according to claim 17, wherein generating the user interface is performed via network

19. The method according to claim 17, further comprising enabling the recipient to register the address and identifier.

20. The method according to claim 19, further comprising generating a code associated with the recipient and storing the code in association with the identifier.

21. The method according to claim 20, further comprising printing a confirmation to be mailed to the address of the recipient, the confirmation including the code and contact information for the recipient to confirm receipt of the confirmation.

22. The method according to claim 21, further comprising:
receiving a communication from the recipient including a submission code; and
verifying the submission code matches the generated code stored in association with the identifier of the recipient.

23. The method according to claim 17, further comprising printing the address.

24. The method according to claim 23, wherein printing the address includes printing a barcode.

25. The method according to claim 17, further comprising:
storing information indicative of mail deliveries to a recipient associated with the identifier, and
displaying the mail delivery information.

26. The method according to claim 25, further comprising:
storing information to block a particular sender from sending mail to an address associated with the recipient;
determining that mail is being sent to the recipient from the sender; and
blocking the mail being sent to the recipient from the sender in response to the determination.

27. The method according to claim 26, wherein storing information associated with the sender includes storing at least a portion of a credit card number.

28. The method according to claim 17, further comprising:
storing information indicative of mail sent from a sender associated with the identifier, and displaying the mail sent information.

29. The method according to claim 17, further comprising:
storing a telephone number in association with the identifier,
looking up the telephone number in response to receiving the identifier, and
causing a telephone call to be placed to the telephone number.

30. A method for providing anonymous mail services, said method comprising:
receiving mail to be delivered to a recipient, the mail including an identifier of the recipient and not including an address or indicia of an address;
looking up an address of the recipient using the identifier of the recipient; and
delivering the mail to the address of the recipient.

31. The method according to claim 30, wherein receiving mail with an identifier of the recipient includes receiving mail with an alphanumeric code.

32. The method according to claim 30, wherein looking up an address of the recipient includes querying a database to locate the address of the recipient.

33. The method according to claim 32, wherein querying a database includes querying a database over a network.

34. The method according to claim 30, wherein receiving mail including an identifier includes receiving mail having a barcode representative of the recipient.
